(19) United States
(12) Patent Application Publication
(10) Pub. No.: US 2012/0146561 A1
(43) Pub. Date: Jun. 14, 2012

(54) ELECTRONICALLY COMMUTATED ELECTRIC MOTOR FEATURING PREDICTION OF THE ROTOR POSITION AND INTERPOLATION, AND METHOD

(75) Inventors: Siegbert Steinlechner, Leonberg (DE); Jo Pletinckx, Grossbottwar (DE)

(73) Assignee: ROBERT BOSCH GMBH, Stuttgart (DE)

(21) Appl. No.: 13/391,076

(22) PCT Filed: Jul. 27, 2010
(86) PCT No.: PCT/EP10/60832

§ 371 Date: Feb. 17, 2012

(30) Foreign Application Priority Data
Aug. 17, 2009 (DE) 10 2009 028 582.2

(51) Int. Cl. H02P 6/16

(52) U.S. Cl. 318/400.04

(57) ABSTRACT

The invention relates to an electronically commutated electric motor comprising a stator and an especially permanent-magnetic rotor. The electric motor also comprises a control unit which is effectively connected to the stator and is designed to generate control signals for commutating the stator in such a way that the stator can generate a rotating magnetic field in order to rotate the rotor. The electric motor further comprises at least one rotor position sensor which is designed to detect a position, especially an angular position, of the rotor and generate a rotor position signal representing the position of the rotor. The control unit is designed to generate the control signals in accordance with the rotor position signal. According to the invention, the control unit is designed to sample and quantize the rotor position signal and generate a digital rotor position signal. The digital rotor position signal forms a time-related data stream which corresponds to the sampled and quantized rotor position signal. The control unit includes an interpolator which is designed to generate at least one intermediate value in the digital rotor position signal, said intermediate value lying between two successive rotor position values.

### BACKGROUND OF THE INVENTION

The invention relates to an electronically commutated electric motor. The electronically commutated electric motor comprises a stator and a rotor. In certain embodiments the rotor is a permanent-magnetic rotor. The electric motor also comprises a control unit which is effectively connected to the stator and is designed to generate control signals for commutating the stator in such a way that said stator can generate a rotating magnetic field in order to rotate the rotor. The electric motor further comprises at least one rotor position sensor which is designed to detect a position, especially an angular position, of the rotor and generate a rotor position signal representing the position of said rotor. The control unit is designed to generate the control signals in accordance with the rotor position signal.

An electric motor is known from the German patent publication DE 103 32 381 A1, in which a rotor position of a rotor is detected without sensors and a current profile of winding currents for rotationally moving the rotor over a rotor revolution runs continuously without abrupt jumps and does not have any current gaps during the detection of the rotor position without sensors.

The problem with rapidly rotating, electronically commutated electric motors is that during an operation of the electric motor, the detection of the rotor position has to be performed with a high detection frequency if during a revolution of the rotor, a frequent change in a commutation pattern is to result. To meet this end, the control unit of the electric motor must then have a correspondingly high computing capacity.

### SUMMARY OF THE INVENTION

According to the invention, the control unit of the electronically commutated electric motor of the kind mentioned at the beginning of the application is designed to sample and quantize the rotor position signal and generate a digital rotor position signal. The digital rotor position signal forms a time-related data stream which corresponds to the sampled and quantized rotor position signal, wherein the control unit includes an interpolator which is designed to generate at least one intermediate value in the digital rotor position signal, said intermediate value lying between two successive rotor position values. By use of an interpolator, a sampling frequency of an analog-digital converter which samples and quantizes the analog rotor position signal can be advantageously smaller than without the interpolator. A computing power of the control unit, which, for example, is formed by an FPGA or an ASIC, can thereby be advantageously smaller than without an interpolator.

The control unit is further preferably designed to generate the digital rotor position signal as a digital prediction-rotor position signal, wherein the digital prediction-rotor position signal, in particular the time-related data stream, comprises at least one or a plurality of future rotor position values which extend temporally beyond the rotor position values. The interpolator is preferably designed to generate the intermediate value between two future rotor position values. As a result of the prediction-rotor position signal formed in this way, the rotor position can advantageously be available for a current rotor position or for future rotor positions for commutating the electric motor. The rotor position predicted in this way can advantageously further be available for commutating the electric motor before the rotor position sensor, in particular an angle sensor, after converting a, e.g., analog rotor position signal to a digital rotor position signal, can make the rotor position signal, which was altered in this way, available for further signal processing.

The rotor position sensor is preferably an angle sensor. The angle sensor is, for example, a giant magneto-resistive sensor (GMR sensor) or an anisotropic magneto-resistive sensor (AMR sensor). In another embodiment, the electric motor comprises, for example, a plurality of Hall sensors, which in each case are designed to generate an especially analog rotor position signal. The angle sensor, in particular the GMR sensor or the AMR sensor, is preferably designed to generate a temporally continuous, preferably representing an absolute rotor position in a temporally continuous manner, especially analog rotor position signal. An angular resolution of the angle sensor is then determined by means of a sampling rate of an analog-digital converter which converts the analog rotor position signal from analog to digital.

In a preferred embodiment, the control unit is designed to correct the digital prediction-rotor position signal in accordance with further rotor positions detected by means of the rotor position sensor particularly according to the FIFO principle (FIFO=First In, First Out). For that purpose, the prediction-rotor position signal can, for example, be formed by a predefined number of rotor position values, wherein said rotor position values are updated according to the FIFO principle with each new rotor position value which is detected by the angle sensor—and furthermore preferably additionally converted by an analog-digital converter. The commutating of the electric motor can thereby also take place with non-stationary movement patterns. For example, the control unit can impinge a large number of commutation patterns, which are different from one another, on the stator during a revolution of the rotor.

In a preferred embodiment, the control unit is designed to generate the digital prediction-rotor position signal using an approximation function in accordance with the rotor position signal as the output function to be approximated. The rotor position signal generated by means of the rotor position sensor can thereby be advantageously estimated for future rotor positions.

The approximation function is preferably a polynomial, in particular at least of the second degree or exactly of the second or third degree. Further advantageous exemplary embodiments for an approximation function are a spline function or an exponential function.

In an advantageous embodiment of the invention, the control unit comprises a timer and is designed to generate the prediction-rotor position signal in accordance with a time signal generated by the timer, wherein the clock frequency of said timer is greater than a repetition rate of successive rotor position values of the digital rotor position signal in order to commutate the stator in accordance with the prediction-rotor position signal. Said stator can thereby be advantageously commutated in accordance with interpolation values of said prediction-rotor position signal.

To meet this end, the control unit can preferably be designed to ascertain the commutation time point at a preferably future rotor position value of the prediction-rotor position signal and is preferably further designed to commutate the stator at a future rotor position value.

The invention also relates to a method for operating an electronically commutated electric motor, in particular the electric motor previously described. In the method, a rotor position is detected using a rotor position sensor and a rotor position signal is generated corresponding to the rotor position. Using the method, the rotor position signal is further preferably sampled and quantized, and an especially digital prediction-rotor position signal forming a time-related data stream is generated. The prediction-rotor position signal represents the sampled and quantized rotor position signal and comprises at least one or a plurality of future rotor position values which extend temporally beyond the rotor position signal.

In a preferred embodiment of the method, the digital prediction-rotor position signal is corrected in accordance with further rotor positions detected using the rotor position sensor.

In an advantageous embodiment variant of the method, the digital prediction-rotor position signal is generated by forming an approximation function as the output function in accordance with the rotor position signal. The output function is thereby the function to be approximated, which can thereby form nodes for generating the approximation function. In so doing, the prediction-rotor position signal can also be extrapolated beyond a region formed by the nodes—for example formed using the rotor position signal or generated from the same. The approximation function is preferably a polynomial function of the second or third degree.

In a preferred embodiment of the method, a commutating of the stator takes place in accordance with the prediction-rotor position signal after a time interval has elapsed, wherein the lapse of time corresponds to a commutation time point. The commutation preferably takes place using at least one, preferably predefined, commutation pattern. In so doing, the commutation advantageously takes place already prior to a presence of a rotor position value that is generated using the rotor position sensor.

In the method, the rotor position value is ascertained in accordance with the approximation function, for example in accordance with the polynomial, the spline function or another suitable approximation function. The multiplications necessary to meet this end can advantageously take place by means of a correspondingly rapid computing unit.

The control unit can, for example, be a microprocessor, a microcontroller or a FPGA (FPGA=Field Programmable Gate Array) or an ASIC (ASIC=Application Specific Integrated Circuit). The control unit is controlled, for example, by a control program, which is stored on a data carrier and together with the data carrier form a computer program product.

The invention also relates to a control unit in accordance with the aforementioned kind for an electric motor of the aforementioned kind The control unit then does not comprise a rotor and a stator and is designed to be connected to a stator of an electric motor.

### BRIEF DESCRIPTION OF THE DRAWINGS

The invention is described below with the aid of figures and further exemplary embodiments. Further advantageous embodiment variants result from the features previously described and from the features specified in the description of the figures as well as from the features specified in the dependent claims.

FIG. 1 shows an exemplary embodiment for an electronically commutated electric motor including the control unit according to the invention;

FIG. 2 shows a method for operating the electric motor depicted in FIG. 1;

FIG. 3 shows a diagram, which clarifies the principle of operation of the electric motor depicted in FIG. 1 as well as the method depicted in FIG. 2.

### DETAILED DESCRIPTION

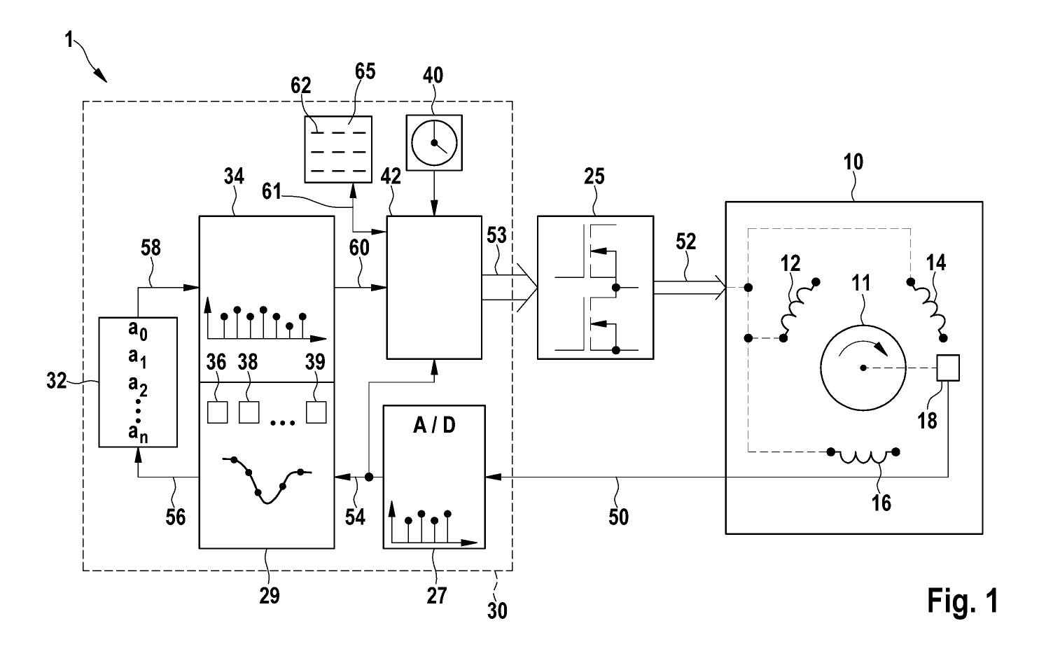

FIG. 1 shows an exemplary embodiment for an electronically commutated electric motor 1. The electric motor 1 comprises a stator 10 having three stator coils, namely a stator coil 12, a stator coil 14 and a stator coil 16. The stator 10 also comprises an angle sensor, which can, for example, generate an analog rotor position signal. The angle sensor 18 is designed to detect a rotor position of a rotor 11 of the electric motor 1. Said angle sensor 18 is connected to a control unit 30 by means of a connection 50. The control unit 30 comprises an analog-digital converter 27, which is connected on the input side to the connection 50 and thus to the angle sensor 18. An angular resolution of the angle sensor is in the case of the analog rotor position signal, in particular the analog rotor position signal which is formed in a temporally continuous manner, determined by a sampling rate of the analog-digital converter. The analog-digital converter 27 is connected on the output side to a polynomial generator 29 via a connecting cable 54.

The analog-digital converter 27 is designed to sample the rotor position signal which is received on the input side via the connection 50 and to generate a temporal sequence of sample values, which in each case represent an amplitude value of the rotor position signal. The analog-digital converter 27 is connected on the output side to a polynomial generator 29 via a connecting cable 54. The polynomial generator 29 is designed to generate an approximation function in accordance with sample values received via the connecting cable 54—representing the rotor position of the rotor 11, said approximation function representing at least approximately a curved line represented in places by the sample values.

The polynomial generator is preferably designed to generate the approximation function using the method of least squares.

The approximation function is preferably a polynomial, in particular a polynomial of the second or third degree. It is also conceivable—in particular in accordance with a required computing time of the polynomial generator—to use a polynomial higher than the third degree.

The polynomial generator 29 is designed to determine polynomial coefficients of the previously ascertained approximation function, in particular of the polynomial, and will output said polynomial coefficients on the output side thereof via a connecting cable 56 to a coefficient storage 32. For this purpose, the polynomial generator 29 has, for example a FIR filter for each polynomial coefficient. In this exemplary embodiment, there are three FIR filters 36, 38 and 39 which are depicted by way of example. The coefficient storage 32 is designed to keep polynomial coefficients generated by the polynomial generator 29 in store. Said coefficient storage 32 is connected on the output side to a predictor 34 via a connecting cable 58. The predictor 34 is designed to read out the coefficients stored in said coefficient storage 32 via the connecting cable 58 and to generate a temporally successive data stream representing rotor position values and to output said data stream on the output side thereof to a control unit 42 via the connecting cable 60. Said data stream thereby comprises temporally successive, future rotor position values—depicted as dots in this exemplary embodiment—which represent in each case a future rotor position that has not yet been detected by the angle sensor 18—in particular having a higher angular resolution than the rotor position signal generated by the analog-digital converter. In this exemplary embodiment, said data stream forms the prediction-rotor position signal mentioned above.

The approximation function, in particular the polynomial, can, for example, be formed as follows:

$${y}_{e , n} ( Δ n ) = {y}_{e} ( ( n + Δ n ) \cdot {T}_{a} ) \approx {\sum }_{i = 0}^{g} {a}_{i} \cdot Δ {n}^{i} ,$$

having

y_{e,n}( )n)=predictor polynomial as the approximation function;

n=sample value, whole number or number <1;

Tₐ=sampling period;

g=degree of the polynomial;

a=polynomial coefficient

The control unit 42 is connected to a timer 40 and is designed to commutate the stator 10 at least in accordance with the prediction-rotor position signal received via the connecting cable 60.

The control unit 42 is connected on the output side to a power output stage 25 of the electric motor 1 via a connection 53. Said control unit 42 is designed to activate the power output stage 25 in order to generate a magnetic rotating field using the stator coils 12, 14 and 16. For that reason, said power output stage 25 is connected on the output side via a connection 52 to the stator 10 and there to the stator coils 12, 14 and 16. Said control unit 42 is designed to exactly determine the commutation time points for commutating the stator 10 in accordance with the in particular high-resolution time signal which is received by the timer 40. Said control unit 42 is connected on the input side to a storage 62 via a bidirectional connection 61. Current application patterns, which differ from one another and from which one current application pattern 62 is described by way of example, are stored in the storage 62. Said control unit 42 can, for example, select one current application pattern from those kept in storage in accordance with the prediction-rotor position signal and supply the stator 10 with current in accordance with the current application pattern in order to generate the rotating field.

The polynomial generator 29 can advantageously have a FIR (FIR=Finite Impulse Response) for each polynomial coefficient of the polynomial coefficients kept in store in the coefficient storage 32.

The control unit 42 is also connected on the input side thereof to the analog-digital converter 27 via the connecting cable 54 and can receive the digitized rotor position signal from said analog-digital converter.

The control unit 42 is designed to activate proportionately the power output stage 35 in order to commutate the stator coils in accordance with the rotor position values calculated by the predictor 34. A temporal repetition rate of the rotor position values of the rotor position signal generated by the predictor is thereby greater than the repetition rate of the digital rotor position signal generated by the analog-digital converter.

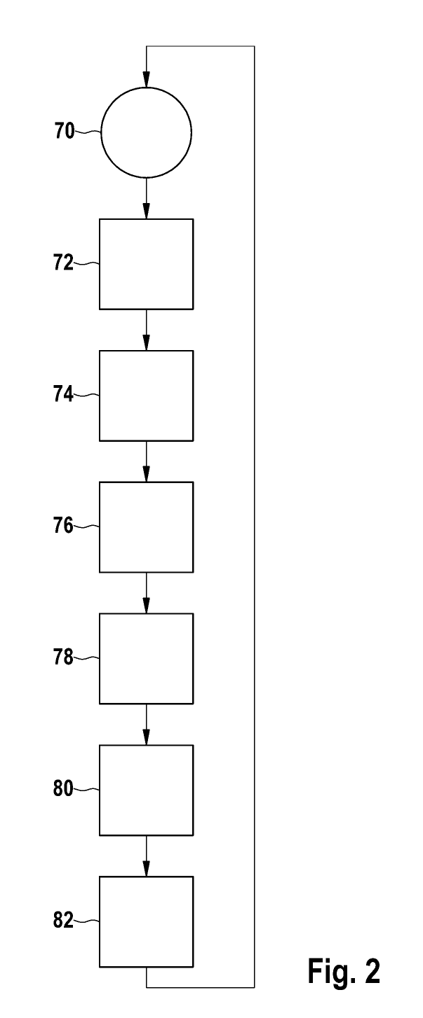

FIG. 2 shows and exemplary embodiment for a method for commutating an electronically commutated electric motor. In the method, a rotor position of a rotor of the electronically commutated electric motor is detected in Step 70 in particular by means of an angle sensor and a rotor position signal is generated, which at least represents a rotor position of the rotor. In Step 72, the rotor position signal is digitized by means of an analog-digital converter and a digitized rotor position signal is generated. In Step 74, a polynomial, which at least closely approximates the digitized rotor position values, is generated in accordance with the digitized rotor position signal. In step 76, polynomial coefficients are temporarily stored, which represent the previously formed polynomial. In Step 78, a polynomial is formed in accordance with the previously generated polynomial coefficients by means of a predictor and a data stream is generated. Said data stream comprises rotor position values in a time range, in which the rotor position values detected by the angle sensor lie and in addition thereto comprises future rotor position values, which have not yet been detected by the angle sensor and/or are not yet represented by the signal generated by the analog-digital converter 24. In this exemplary embodiment, said data stream further comprises rotor position values generated by interpolating so that a temporal clock frequency of the successive rotor position values of said data stream is greater than a sampling rate during analog-digital convertsion. In Step 80, a commutation pattern is selected in accordance with said data stream and in Step 82, current is applied to the stator according to the commutation pattern.

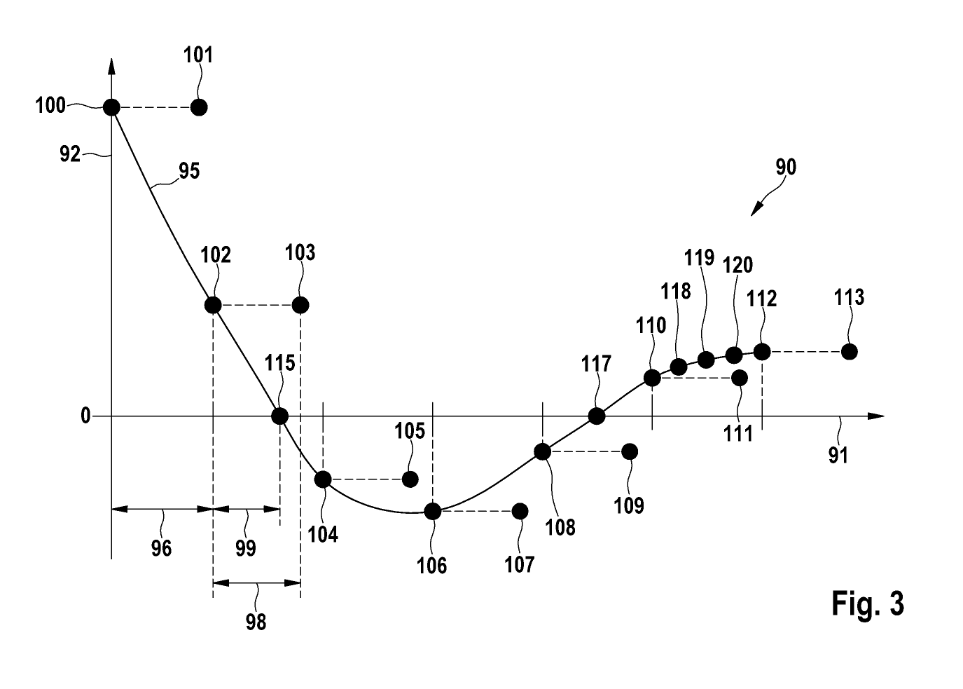

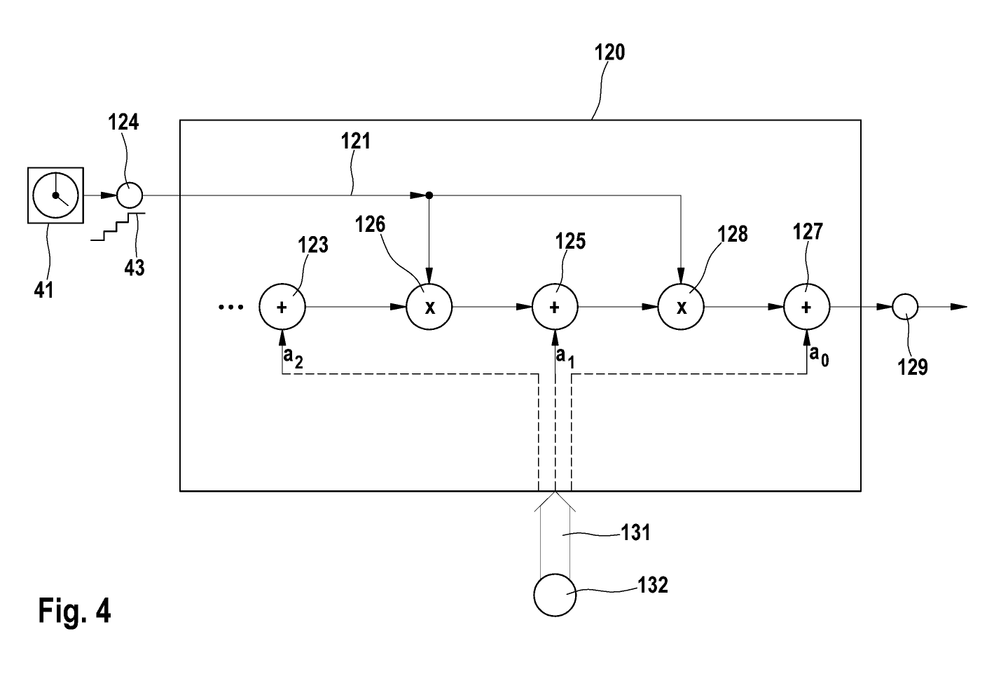

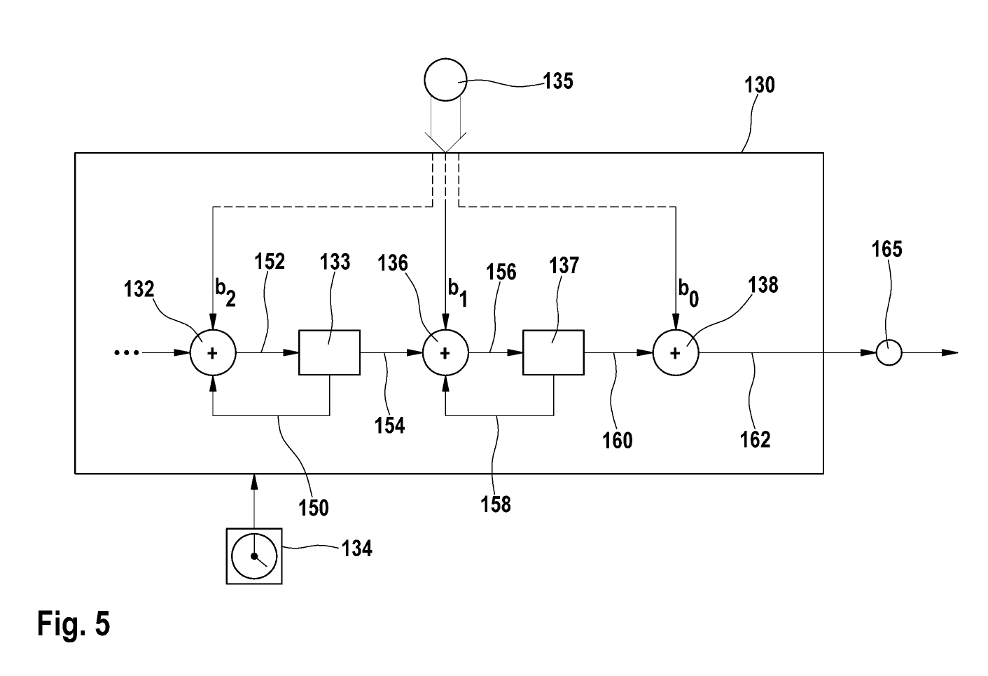

FIG. 3 shows a diagram 90. The diagram 90 comprises a time axis 91 and an amplitude axis 92.

The diagram 90 shows a curve 95, which connects sample values 101, 102, 104, 106, 108, 110 and 112 to one another. The curve 95 corresponds to a polynomial, which, for example, has been generated by the polynomial generator 29 depicted in FIG. 1 and which represents a rotor position profile. The polynomial is a polynomial of the third degree in this exemplary embodiment.

Rotor position values 101, 103, 105, 107, 109, 111 and 113 are also depicted.

The rotor position value 101 has been detected by the angle sensor, thus, for example, by the angle sensor depicted in FIG. 1.

A time interval 96 and a time interval 98 are also depicted. The time interval 96 represents a sampling period of an analog-digital converter, for example, the analog-digital converter 27 depicted in FIG. 1.

The rotor position values 100, 102, 104, 106, 108, 110 and 112 are in each case spaced at preceding and at succeeding rotor position values by means of the time interval 96.

The rotor position value 101 follows the rotor position value 100 after the time interval 98. The rotor position value 103 follows the rotor position value 102 after the time interval 98. Said time interval 98 thereby represents a computing time, which the analog-digital converter requires in order to execute the digitization of the rotor position signals sent by the angle sensor.

The rotor position signals detected by the angle sensor are available in digitized form to the control unit—for example the control unit 30 in FIG. 1—for further signal processing and for controlling the commutation time points later—in this example delayed by the time interval 98—than said rotor position signals were detected by the angle sensor. The commutation time points 115 and 117 are depicted. The commutation time point 115 is spaced from the rotor position value 102 by the time interval 99. The time interval 99 is shorter than the time interval 98 so that the commutation time point 115 occurs after the digital rotor position value 103 has been made available—said commutation time point corresponding to the rotor position of the rotor position value 102. Intermediate values 118, 119 and 120 are also shown, which have been generated by the interpolator and in each case represent a rotor position.

By generating the predictor polynomial and predicting the future rotor position values, which have not yet been detected by the angle sensor, a sampling frequency for detecting a rotor position of the rotor can be lower than without the prediction using the predictor polynomial. The low sampling frequency of the sampling of the rotor position signal is further advantageously compensated or improved by means of interpolation.

If, for example the rotor position values 100, 102, 104 and 106 have been detected by the angle sensor, the rotor position value 108, the rotor position value 110 and the rotor position value 112 as well as the intermediate values 118, 119, 120 can have been generated using the predictor polynomial.

In a further development of the method for commutating the electric motor, the control unit, for example the control unit 42 in FIG. 1, can compare the rotor position values 108, 110 and 112 generated using the predictor with the rotor position values 109, 111 or respectively 113 detected by the angle sensor and use the results to form a further polynomial profile of the predictor polynomial.

FIG. 4 shows an exemplary embodiment for a predictor 120, which, for example, can be a component of the electric motor 1 in place of the predictor 34 shown in FIG. 1. The predictor 120 comprises an input 124 and an output 129. The input 124 is connected to the timer 40 already depicted in FIG. 1. Said input 124 is connected to a multiplier 126 and a multiplier 128 via a connecting cable 121. The multiplier 126 is also connected on the input side to an adder 123. The adder 123 is connected on the input side to a connection 131 and to an input 132 via said connection 131. The adder 123 can receive a polynomial coefficient via the input 132, in this exemplary embodiment a polynomial coefficient a₂ of a polynomial of the second degree.

The multiplier 146 is connected on the output side to an adder 125. The adder 125 is connected on the input side to the multiplier 126 and also on the input side to the connection 131 that is of multi-channel design. Said adder 125 can receive a polynomial coefficient via the multi-channeled connection 131 and thus from the input 132, in this exemplary embodiment a polynomial coefficient a₁ of the polynomial of the second degree. Said adder 125 is connected on the output side to the multiplier 128. The multiplier 128 is connected on the output side to the adder 127. The adder 147 is connected on the input side to the multiplier 128 and also on the input side to the input 132 via the connection 131 and can receive via said connection 131 a polynomial coefficient, in this exemplary embodiment a polynomial coefficient a₀ of the polynomial of the second degree. The adder 127 is connected on the output side to the output 129. During an operation of the timer 41, the predictor 120 can, for example, receive an especially ramp-shaped clock pulse signal 43 via the input 124, the clock frequency of which is a multiple of a sampling frequency used by the analog-digital converter 27 during the analog-digital conversion. The clock pulse signal is, for example, designed ramp-shaped and has a predefined number of ramp steps. With each clock pulse period, in particular ramp step, of the clock pulse signal 43 received at the input 124, the multiplier 126 multiplies an output signal received by the adder 123 with the clock pulse signal and outputs on the output side a multiplication result to the adder 125. The adder 121 adds the multiplication result received from the multiplier 126 with the polynomial coefficient a₁ received from the input 132 and outputs on the output side a corresponding addition result to the multiplier 128. The multiplier 128 multiplies the addition result received from the adder 125 with the clock signal, which the multiplier 126 also received from the input 124. The multiplier 128 generates a corresponding multiplication result and outputs said result on the output side to an adder 127. The adder 127 adds the multiplication result generated by the multiplier 128 to a polynomial coefficient a₀, which the adder 127 received from the input 132 via the connection 131. The adder 127 can then output the addition result to the output 129—as a prediction-rotor position signal. The adder 123 can on the input side—depicted as dots—in the case of a polynomial higher than the second degree be connected to at least one further multiplier. The input 132 is, for example, connected to the connecting cable 58 depicted in FIG. 1 and thus to the coefficient storage 32.

FIG. 5 shows an exemplary embodiment for a predictor 130. The predictor 130 can, for example, replace the predictor 34 in FIG. 1. Said predictor 130 does not have—in contrast to the predictor 120 in FIG. 4—a multiplier and can thus be provided in a manner allowing easy implementation—for example using an ASIC.

The predictor 130 has an input 135 and an output 165 and is connected to a timer 134.

The predictor 130 comprises a plurality of integrators, which particularly together form a cascade. The integrators comprise in each case an adder and a storage. An adder 132 is depicted which is connected on the output side to a storage 133 via a connecting cable 152. The storage 133 is connected on the output side to a further adder 136 via a connecting cable 154. Said storage 133 is also connected on the output side to the adder 132 via a feedback connecting cable 154. The storage 133 is also connected on the output side to the adder 132 via a feedback connecting cable 150. The adder 132 forms together with the storage 133 an integrator.

The storage 133 is connected on the output side to the adder 136 via a connecting cable 154. The adder 136 is connected on the output side to a storage 137 via a connecting cable 156. The storage 137 is connected in feedback relation on the output side to the adder 136 via a connecting cable 158. The storage 147 is also connected on the output side to an adder 138 via a connecting cable 160. Said adder 138 is connected on the output side to the output 165 via a connecting cable 162.

The adder 138, the adder 136 and the adder 132 are also in each case connected on the input side to an input 135 and can receive a polynomial coefficient via said input 135. The predictor 130 can be connected, for example, to the coefficient storage 32 depicted in FIG. 1 via the input 135 and receive the polynomial coefficients from said coefficient storage 32.

The polynomial coefficients can be generated, for example, from the polynomial generator 29 as follows, in particular in accordance with the sampling rate of the analog-digital converter 27 in FIG. 1:

$${b}_{0} = {a}_{0}$$

$${b}_{1} = \frac{{a}_{1}}{L} + \frac{{a}_{2}}{{L}^{2}}$$

$${b}_{2} = \frac{{a}_{2}}{2 \cdot {L}^{2}}$$

having

b₀, b₁, b₂ as clock pulse dependent polynomial coefficients

L=multiple of the sampling frequency Tₐ of the analog-digital converter 27 in FIG. 1

The computing unit formed using the predictor 130 can be implemented by means of a microprocessor, a microcontroller or an FPGA (FPGA=Field Programmable Gate Array) or an ASIC (ASIC=Application Specific Integrated Circuit). The connection between the input 134 and the adder 132 is partially depicted with dots. This means that the predictor 130 can comprise further integrators, which are connected to the adder 132, for calculating a polynomial of a higher degree. The predictor 130 is also connected on the input side to the timer 134. The timer 134 is, for example, designed to produce a time signal which has an especially L-fold higher clock rate than a sampling rate used by the analog-digital converter 27.

The integrators of the predictor 130 are in each case connected to the timer 134 and perform in each case an arithmetic operation with the clock pulse specified by the timer 134. The polynomial coefficients b₀, b₁ and b₂ are made available from the input 135 with the clock pulse of the sampling frequency. The time 134 is, for example, designed to generate the clock pulse for clocking the integrators according to the following specification:

$${f}_{Takt} = L \cdot \frac{1}{{T}_{a}}$$

having

f_{Takt}=clock frequency of the clock pulse for clocking the integrators,

Tₐ=sampling period, for example of the analog-digital converter 27 in FIG. 1

L=factor, advantageously as a power of a number L=2ⁿ

The factor L is advantageously selected as a power of the base of 2. The division operations for generating the polynomial coefficients b₀, b₁ and b₂, additionally preferred bₙ can thus advantageously be generated using addition operations. The predictor 130 can thus output at output 165 the polynomial generated using the polynomial coefficients received at the input 135—as a prediction-rotor position signal. The output 165 can, for example, be connected to the connecting cable 60 depicted in FIG. 1 so that the predictor 130 is connected on the output side to the control unit 42. The control unit 42 can, for example, in accordance with the polynomial received from the predictor 130—as the prediction-rotor position signal—select a current application pattern 62 from the storage 65 and apply current to the stator 10 of the electric motor 1 using the power output stage 25 in accordance with the current application pattern.

1. An electronically commutated electric motor comprising a stator, rotor, and a control unit, which is effectively connected to the stator and is designed to generate control signals for commutating said stator in such a way that said stator can generate a rotating magnetic field in order to rotate the rotor, and the electric motor has at least one rotor position sensor, which is designed to detect a rotor position of the rotor and generate a rotor position signal representing the position of said rotor, and the control unit is designed to generate the control signals in accordance with the rotor position signal, wherein the control unit is designed to sample and quantize the rotor position signal and generate a digital rotor position signal, which forms a time-related data stream which corresponds to the sampled and quantized rotor position signal, wherein said control unit includes an interpolator which is designed to generate at least one intermediate value in the digital rotor position signal, said intermediate value lying between two successive rotor position values.

2. The electric motor according to claim 1, wherein the control unit is designed to generate the digital rotor position signal as a digital prediction-rotor position signal, which comprises at least one or a plurality of future rotor position values that extend temporally beyond the rotor position signal and the interpolator is designed to generate the intermediate value between two future rotor position values.

3. The electric motor according to claim 2, wherein the control unit is designed to correct the digital prediction-rotor position signal in accordance with further rotor positions detected using the rotor position sensor.

4. The electric motor according to claim 2, wherein the control unit is designed to generate the digital prediction-rotor position signal using an approximation function in accordance with the rotor position signal as an output function.

5. The electric motor according to claim 4, wherein the approximation function is a polynomial.

6. The electric motor according to claim 1, wherein the control unit comprises a timer and is designed to generate the prediction-rotor position signal in accordance with a time signal generated by the timer, wherein a clock frequency of the timer is greater than a repetition rate of successive rotor position values of the digital rotor position signal, and is designed to commutate the stator in accordance with the prediction-rotor position signal.

7. A method for operating an electronically commutated electric motor comprising a rotor, according to claim 1, in which a rotor position of a rotor is detected using a rotor position sensor and a rotor position signal corresponding to the rotor position is generated, and in which the rotor position signal is sampled and quantized and a digital rotor position signal forming a time-related data stream is generated, said digital rotor position signal representing the sampled and quantized rotor position signal, wherein by means of interpolation, at least one intermediate value lying between two successive rotor position values is generated in the digital rotor position signal.

8. The method according to claim 7, in which the digital rotor position signal is generated as a digital prediction-rotor position signal which comprises at least one or a plurality of future rotor position values which extend temporally beyond the rotor position signal, and the interpolator is designed to generate the intermediate value between two future rotor position values.

9. The method according to claim 8, in which the digital prediction-rotor position signal is corrected in accordance with further rotor positions detected by means of the rotor position sensor according to the First In, First Out principle.

10. The method according to claim 8, characterized in that the digital prediction-rotor position signal is generated as the output function by forming an approximation function in accordance with the rotor position signal.

11. The method according to claim 10, characterized in that the approximation function is a polynomial function, particularly at least of the second degree.

12. The method according to claim 9, characterized in that the approximation function is a spline function.

13. The method according to claim 8, characterized in that a commutation of the stator takes place in accordance with the prediction-rotor position signal,
